(19) United States
(12) Patent Application Publication
(10) Pub. No.: US 2010/0290415 A1
(43) Pub. Date: Nov. 18, 2010

(54) Apparatus and method for bandwidth request in broadband wireless communication system

(75) Inventors: Ki-Tae Han, Suwon-si (KR); Kang-Sung Yang, Hwaseong-si (KR); Jung-Ho Han, Seoul (KR); Jung-Hun Park, Yongin-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/800,001

(22) Filed: May 6, 2010

(30) Foreign Application Priority Data
May 13, 2009 (KR) 10-2009-0041527

(51) Int. Cl. H04W 72/04; H04W 84/02

(52) U.S. Cl. 370/329; 370/338

(57) ABSTRACT

A transmission delay caused by a Bandwidth Request (BR) of a Mobile Station (MS) in a broadband wireless communication system can be avoided. An operation of the MS includes performing an initial BR to allocate resources across a plurality of frames. When a resource is allocated according to the initial BR, an adaptive BR is performed on the resource in a piggyback manner by using the resource while transmitting an acknowledge (ACK) message corresponding downlink Transmission Control Protocol (TCP) data.

### CROSS-REFERENCE TO RELATED APPLICATION(S) AND CLAIM OF PRIORITY

The present application claims the benefit under 35 U.S.C. §119(a) of a Korean patent application filed in the Korean Intellectual Property Office on May 13, 2009 and assigned Serial No. 10-2009-0041527, the entire disclosure of which is hereby incorporated by reference.

### TECHNICAL FIELD OF THE INVENTION

The present invention relates to a broadband wireless communication system. More particularly, the present invention relates to an apparatus and method for a Bandwidth Request (BR) in a broadband wireless communication system.

### BACKGROUND OF THE INVENTION

In the next generation communication system, also known as the 4^{th} Generation (4G) communication system, researches are actively in progress to provide users with a Quality of Service (QoS) that includes a data transfer speed of about 100 Mbps. In particular, the 4 G communication system is currently being developed to ensure mobility and QoS in a Broadband Wireless Access (BWA) communication system, such as a Wireless Local Area Network (WLAN) system and a Wireless Metropolitan Area Network (WMAN) system. A representative example of such a communication system is an Institute of Electrical and Electronics Engineers (IEEE) 802.16 system.

A mobile worldwide interoperability for microwave access (also known as WiMAX) system is one of the wireless communication systems that conform to the IEEE 802.16 standard. In the WiMAX system, a Mobile Station (MS) manages an UpLink (UL) transmission queue for each connection depending on a QoS type, and a Media Access Control (MAC) scheduler included in the MS performs a Bandwidth Request (BR) based on data stored in the queue. Thereafter, when a resource is allocated from a Base Station (BS) according to the BR, the MS transmits the data by using the allocated resource.

When the MS performs File Transport Protocol (FTP) communication, FTP DownLink (DL) acknowledge (ACK) for FTP DL data is input to the queue. The MAC scheduler of the MS performs the BR according to a packet input to the queue. In this example, if the packet is newly input to the queue after the BR is generated and thus an amount of data stored in the queue at a time of allocating a resource increases in comparison with a time of performing the BR, the MS performs the BR for the packet newly input to the queue in a piggyback manner while transmitting the packet by using the allocated resource.

However, several frames are delayed until resources are allocated according to the BR, that is, until the resources are allocated to the MS via an allocation scheduler of the BS after the MS performs the BR and the BS receives the BR. Therefore, when performing an application such as a Transmission Control Protocol (TCP) in which a plurality of packets are not generated in an UL direction, transmission of a TCP ACK packet is delayed by an amount of delay caused by the BR in every ACK transmission. As a result, transmission of the ACK packet for a TCP DL packet is delayed, and a DL throughput is limited due to a TCP property of limiting a window size.

In addition, the MAC scheduler of the MS cannot correctly recognize a size of data provided from a higher-layer host until a packet is transmitted by allocating a resource after the BR is generated. Accordingly, when the BR is performed, a necessary resource amount cannot be correctly predicted and requested at a time of actually transmitting data. Therefore, when the MS requests a greater amount of resources than an amount of resources for sending data to be actually transmitted when the BR is performed, the MS performs unnecessary padding to cover all allocated resources because the host does not input additional data. The unnecessary padding results in a waste of radio resources, thereby decreasing system capacity.

As described above, a BR process for ACK packet transmission may result in DL communication delay or radio resource waste. Accordingly, there is a need to provide a method for solving the aforementioned problem and for effectively performing the BR.

### SUMMARY OF THE INVENTION

To address the above-discussed deficiencies of the prior art, it is a primary aspect of the present invention to provide an apparatus and method for avoiding transmission delay caused by a Bandwidth Request (BR) in a broadband wireless communication system.

Another aspect of the present invention is to provide an apparatus and method for avoiding radio resource waste caused by a BR for a resource amount that is more than necessary amount in a broadband wireless communication system.

Another aspect of the present invention is to provide an apparatus and method for allocating resources across a plurality of frames by performing a BR once in a broadband wireless communication system.

Another aspect of the present invention is to provide an apparatus and method for performing a BR by predicting generation of an acknowledge (ACK) packet in a broadband wireless communication system.

In accordance with an aspect of the present invention, a method of a BR of a Mobile Station (MS) in a broadband wireless communication system is provided. The method includes performing an initial BR to allocate resources across a plurality of frames. When a resource is allocated according to the initial BR, an adaptive BR is performed on the resource in a piggyback manner by using the resource while transmitting an ACK corresponding downlink Transmission Control Protocol (TCP) data.

In accordance with another aspect of the present invention, a method of allocating a resource of a Base Station (BS) according to a BR in a broadband wireless communication system is provided. The method includes, upon receiving a Bandwidth Request Header (BRH) from an MS, determining whether the BRH is a periodic resource request BRH. If the BRH is the periodic resource request BRH, the method also includes identifying an allocation interval, an allocation count, and a required resource amount by using the periodic resource request BRH. The resource is allocated by the required resource amount and by the allocation count in every allocation interval.

In accordance with another aspect of the present invention, an MS apparatus in a broadband wireless communication system is provided. The apparatus includes a generator that generates a control message for an initial BR to allocate resources across a plurality of frames. A transmitter is configured to transmit an ACK corresponding downlink TCP data, and a burst includes control information for an adaptive BR in a piggyback manner by using a resource, when the resource is allocated by the initial BR.

In accordance with another aspect of the present invention, a BS apparatus in a broadband wireless communication system is provided. The apparatus includes a parser that determines whether a BRH is a periodic resource request BRH upon receiving the BRH from an MS. If the BRH is the periodic resource request BRH, the parser is further configured to identify an allocation interval, an allocation count, and a required resource amount by using the periodic resource request BRH. An allocator is configured to allocate the resource by the required resource amount and by the allocation count in every allocation interval.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a Bandwidth Request (BR) for Transmission Control Protocol (TCP) acknowledge (ACK) transmission in a broadband wireless communication system according to an embodiment of the present invention;

FIG. 2 illustrates a periodic resource request Bandwidth Request Header (BRH) in a broadband wireless communication system according to an embodiment of the present invention;

FIG. 3 illustrates a BR for ACK transmission in a broadband wireless communication system according to an embodiment of the present invention;

FIG. 4 illustrates an operation of a Mobile Station (MS) in a broadband wireless communication system according to an embodiment of the present invention;

FIG. 5 illustrates an operation of an MS in a broadband wireless communication system according to an embodiment of the present invention;

FIG. 6 illustrates an operation of a Base Station (BS) in a broadband wireless communication system according to an embodiment of the present invention;

FIG. 7 illustrates an MS in a broadband wireless communication system according to an embodiment of the present invention; and

FIG. 8 illustrates a BS in a broadband wireless communication system according to an exemplary embodiment of the present invention.

### DETAILED DESCRIPTION OF THE INVENTION

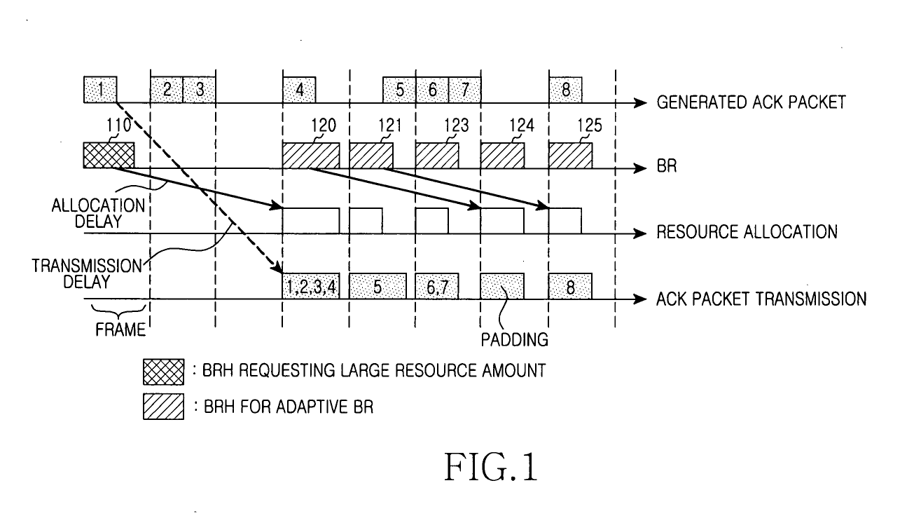

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system.

Hereinafter, a technique for avoiding communication delay and resource waste caused by a Bandwidth Request (BR) in a broadband wireless communication system will be described. The following description will be explained by focusing on a wireless communication system based on Orthogonal Frequency Division Multiplexing (OFDM)/Orthogonal Frequency Division Multiple Access (OFDMA), and can also equally apply to other types of wireless communication systems.

In order to increase a throughput of a Transmission Control Protocol (TCP), it is preferable not to delay an acknowledge (ACK) transmission corresponding TCP DownLink (DL) data. A Mobile Station (MS) parses data input to a Media Access Control (MAC) layer and identifies ACK for the TCP DL data such that the ACK transmission is not delayed. Further, the MS recognizes a pattern according to which the ACK is input during a specific time, and adaptively performs the BR according to the pattern. Herein, performing of the BR implies transmission of a Bandwidth Request Header (BRH), and the BRH includes a required resource amount and identification information of the MS. The BR, depending on the pattern, will be hereinafter referred to as ‘adaptive BR’. That is, when an ACK packet is persistently generated, the MS performs the BR in every frame. Thus, every frame resource is allocated to the MS, and the ACK packet is immediately transmitted by the MS without delay. In this case, the MS performs the BR by referencing a resource state of the system. For this, the system reports an UpLink (UL) resource state by using an UL map. Therefore, the MS recognizes the resource state by using the UL map and determines whether padding can be allowed. If the padding is allowed as a result of the determination, the MS performs the BR such that ACK transmission is achieved without delay while minimizing the padding.

The aforementioned BR process will be described in detail.

The MAC layer of the MS parses all pieces of data provided from an application layer (i.e., a higher layer of the MAC layer), and identifies ACK for FTP DL data. When the number of detected ACK signals for the FTP DL data is greater than or equal to a specific number, the MS performs a BR that requests a resource amount as large as that can be allocated across a plurality of frames in a divisive manner. As a result, after the elapse of an allocation delay time depending on the BR, resources are allocated across the plurality of frames in a divisive manner. Accordingly, the MS transmits ACK packets by using resource regions included in each frame allocated. At the same time, an adaptive BR is performed in a piggyback manner irrespective of the presence or absence of data remaining in the queue. In this situation, the MS determines a required resource amount of the adaptive BR such that the ACK packet can be transmitted without delay while minimizing padding by predicting ACK packet generation for a DL FTP packet to be received persistently. For example, the MS compares a data amount of an ACK packet stored in a current queue and a data amount of an old statistical ACK packet and determines the required resource amount of the adaptive BR by using a greater value between the two compared values. Accordingly, even if allocation delay exists due to the BR, a resource is allocated for each frame due to the adaptive BR performed in every frame. Therefore, an allocated resource region exists whenever an ACK packet is generated, and thus the ACK packet can be transmitted without having to wait during an allocation delay for the BR. Consequently, delay of the ACK packet is minimized and thus an FTP server increases a window size, leading to an increased DL transfer rate. In this situation, if the ACK packet for FTP DL data is not generated during a specific time, the MS terminates the adaptive BR performed in every frame, thereby excluding an unnecessary BR.

The BR for TCP ACK packet transmission as described above is illustrated in FIG. 1. FIG. 1 illustrates a conceptual view of a BR for TCP ACK transmission in a broadband wireless communication system according to an embodiment of the present invention. Referring to FIG. 1, upon detecting generation of a specific number (or more) of TCP ACK packets during a specific time period, an MS performs an initial BR by using a BRH 110 that requests a large resource amount. Accordingly, a resource is allocated after a specific allocation delay time elapses, and the MS transmits ACK packets stored in a queue by using the allocated resource. Because resources are allocated across a plurality of frames due to the BRH 110 that requests the large resource amount, the MS transmits an ACK packet generated at a later time without delay. In this example, starting from a frame in which transmission of the ACK packet starts, the MS transmits BRHs 120 to 125 for an adaptive BR in every frame in a piggyback manner. Accordingly, at the completion of resource allocation performed by using the BRH 110 that requests the large resource amount, resource allocation is continued by using the BRHs 120 to 125 for the adaptive BR, and the MS persistently transmits ACK packets generated in every frame without delay.

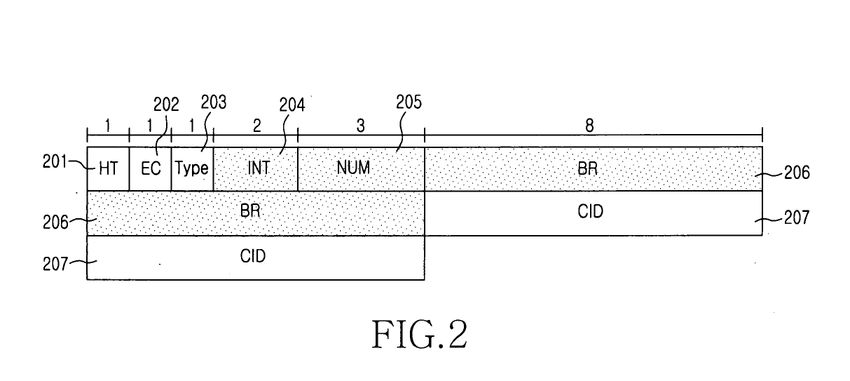

In the first exemplary embodiment of the present invention, the initial BR is performed by using a BRH requesting a resource amount as large as that can be allocated across a plurality of frames. However, according to another exemplary embodiment of the present invention, the initial BR is performed by using a BRH periodically requesting a specific amount of resources. Hereinafter, the BRH periodically requesting the specific amount of resource is referred to as ‘periodic resource request BRH’. For example, the periodic resource request BRH can be configured as illustrated in FIG. 2.

FIG. 2 illustrates a structure of a periodic resource request BRH in a broadband wireless communication system according to an embodiment of the present invention. Referring to FIG. 2, the periodic resource request BRH includes a Header Type (HT) 201, an Encryption Control (EC) 202, a type 203, an interval (INT) 204, a number (NUM) 205, a Bandwidth Request (BR) 206, and a Connection Identifier (CID) 207. The INT 204 indicates an allocation interval. The NUM 205 indicates an allocation count. The BR 206 indicates a required resource amount. The HT 201, the EC 202, the type 203, and the CID 207 are included in common with the typical BRH. The CID 207 is identification information for identifying traffic flow. The HT 201, the EC 202, and the type 203 are information for indicating a format of the BRH. Therefore, the MS indicates that the BRH is the periodic resource request BRH by setting the type 203 to a value corresponding to the periodic resource request BRH. For example, for the periodic resource request BRH, the HT 201, the EC 202, and the type 203 are set to ‘111’.

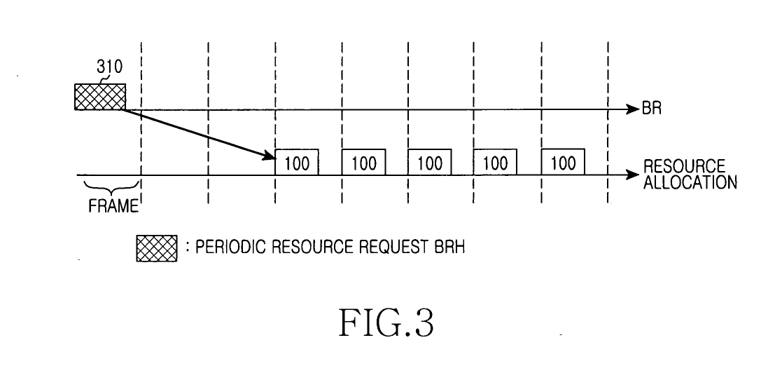

When using the periodic resource request BRH as illustrated in FIG. 2, resource allocation based on an initial BR is achieved as illustrated in FIG. 3. FIG. 3 illustrates a conceptual view of a BR for ACK transmission in a broadband wireless communication system according to an embodiment of the present invention. In FIG. 3, the initial BR is performed using a periodic resource request BRH in which a resource amount is set to 100, an allocation count is set to 5, and an allocation period is set to 1. Referring to FIG. 3, upon detecting generation of a specific number (or more) of TCP ACK packets during a specific time period, the MS performs the initial BR by using a periodic resource request BRH 310. Accordingly, resources with a size of 100 are allocated 5 times in every frame after a specific allocation delay time elapses, and the MS transmits ACK packets stored in a queue in every frame by using the allocated resources.

Hereinafter, operations and structures of an MS for performing a BR and a BS for allocating a resource will be described in detail with reference to the accompanying drawings.

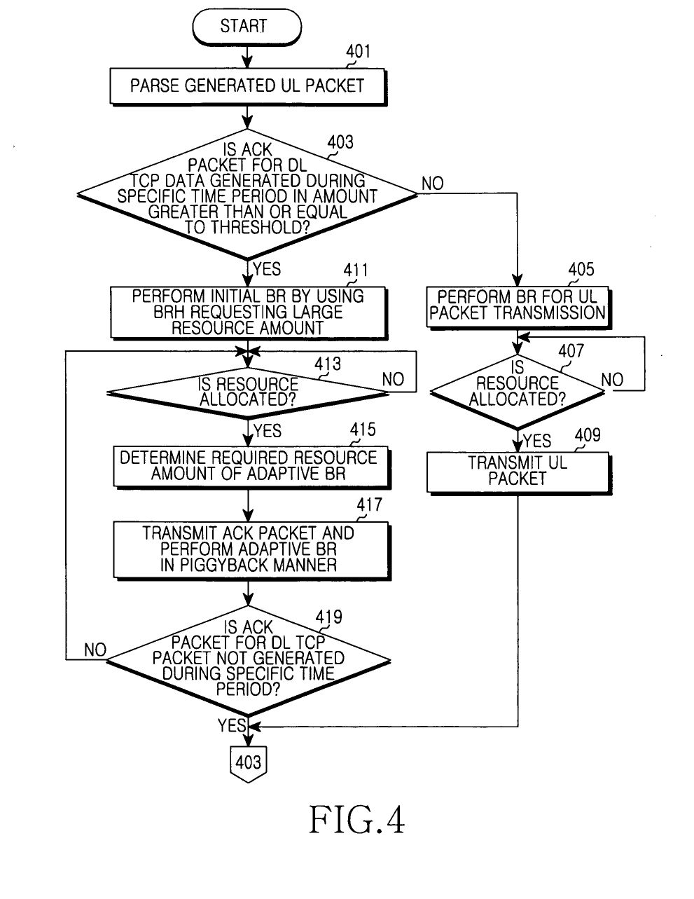

FIG. 4 illustrates an operation of an MS in a broadband wireless communication system according to an embodiment of the present invention.

Referring to FIG. 4, the MS parses a UL packet generated in a higher layer of a MAC layer in block 401. In other words, the MS classifies UL packets input to a UL data queue of the MAC layer by using a size and an Internet Protocol (IP) header. In particular, the MS identifies an ACK packet for DL TCP data among the UL packets. Herein, the MS classifies a TCP packet with a specific size or smaller into the ACK packet.

In block 403, the MS determines whether the ACK packets for the DL TCP data are generated during a specific time period in an amount greater than or equal to a threshold. In other words, the MS determines whether a condition for performing an adaptive BR is satisfied.

If the ACK packets are generated during the specific time period in an amount less than the threshold, proceeding to block 405, the MS performs a BR for transmission of a UL packet stored in the UL data queue. That is, the MS determines a required resource amount by considering a size of the DL packet stored in the UL data queue, and transmits a BRH including information on the required resource amount. In this situation, if there is a UL packet to be transmitted, the BR may be performed in a piggyback manner.

In block 407, the MS determines whether a resource is allocated according to the BR performed in block 405. In other words, the MS determines whether the UL resource is allocated by a required resource amount included in the BRH. Herein, allocation of the resource is achieved after an allocation delay time elapses.

When the resource is allocated, proceeding to block 409, the MS transmits the UL packet stored in the UL data queue by using the allocated resource. That is, the MS performs coding and modulation on a bit-stream of the UL packet to convert the bit-stream into complex symbols, and maps the complex symbols to the allocated resource. Thereafter, the MS configures an OFDM symbol by performing an Inverse Fast Fourier Transform (IFFT) operation and Cyclic Prefix (CP) insertion. Further, the MS up-converts the OFDM symbols into a Radio Frequency (RF) signal, and then transmits the RF signal through an antenna. Thereafter, the procedure returns to block 403.

If the ACK packets are generated during the specific time period in an amount greater than or equal to the threshold in block 403, proceeding to block 411, the MS performs the initial BR by using a BRH that requests a large resource amount. Herein, the large resource amount is as large as that can be allocated across a plurality of frames, and indicates an amount exceeding a maximum amount of resources that can be allocated for each frame. In addition, the plurality of frames include a length greater than or equal to an allocation delay time. In other words, requesting of the large resource amount implies that a request is generated such that an allocation delay until allocation is achieved after the BR is recognized and thereafter allocation is continuously achieved by a frame corresponding to the allocation delay. For example, if a maximum resource amount allocated per one frame is predetermined in a UL frame structure, the large resource amount is identical to a size corresponding to {maximum allocation size per frame}×{number of allocation delay frames}.

In block 413, the MS determines whether a resource is allocated according to the initial BR performed in block 411 or the adaptive BR to be performed in block 417. In other words, the MS determines whether some UL resources are allocated among the required resource amount included in the BRH. Herein, the resource is allocated after an allocation delay time elapses.

When the resource is allocated, proceeding to block 415, the MS determines a required resource amount of the adaptive BR. Herein, the required resource amount of the adaptive BR is determined such that the ACK packets are transmitted without delay while minimizing padding. For example, the MS determines the required resource amount by selecting a greater value between a data amount of an ACK packet currently stored in a UL data queue and a data amount of an old statistical ACK packet. For example, the data amount of the statistical ACK packet implies an average of data amounts of ACK packets stored in the UL data queue at respective transmission times of recent N frames.

After determining the required resource amount of the adaptive BR, proceeding to block 417, the MS transmits the ACK packet by using the allocated resource while performing the adaptive BR in a piggyback manner. That is, the MS transmits the ACK packet and a burst including the adaptive BR by using the allocated resource. In other words, the MS transmits the ACK packet and the burst including a BRH for the adaptive BR.

In block 419, the MS determines whether an ACK packet for DL TCP data is not generated during the specific time period. Herein, a length of the specific time period is not necessarily equal to the length of the specific time period in block 403, and thus the two lengths may be equal to or different from each other. If the ACK packet for the DL TCP data is not generated during the specific time period, the MS terminates the adaptive BR, and the procedure returns to block 403. Otherwise, if the ACK packet for the DL TCP data is persistently generated, returning to block 413, the MS performs the adaptive BR.

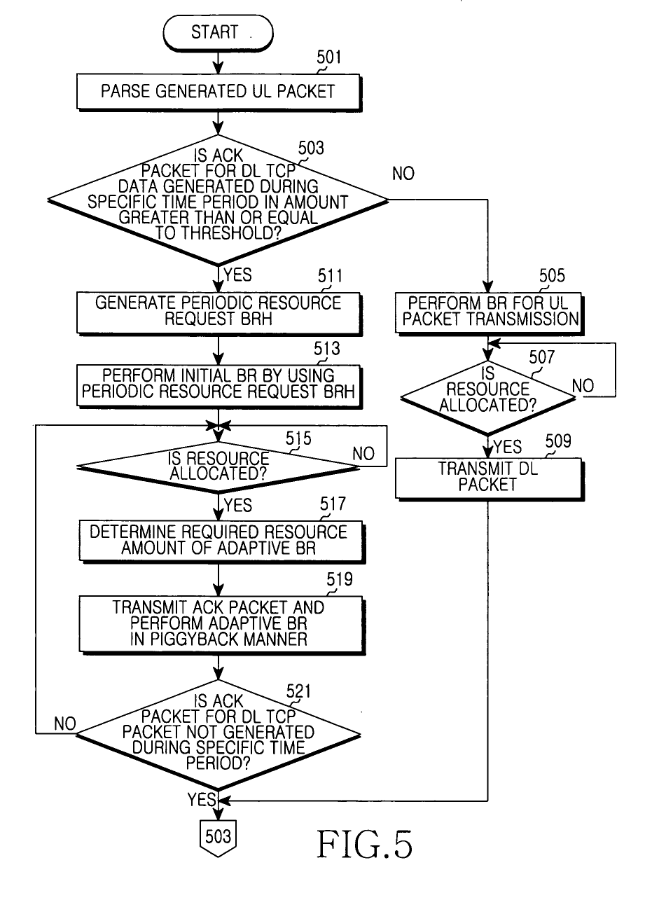

FIG. 5 illustrates an operation of an MS in a broadband wireless communication system according to an embodiment of the present invention.

Referring to FIG. 5, the MS parses a UL packet generated in a higher layer of a MAC layer in block 501. In other words, the MS classifies UL packets input to a UL data queue of the MAC layer by using a size and an IP header. In particular, the MS identifies an ACK packet for DL TCP data among the UL packets. Herein, the MS classifies a TCP packet with a specific size or smaller into the ACK packet.

In block 503, the MS determines whether the ACK packets for the DL TCP data are generated during a specific time period in an amount greater than or equal to a threshold. In other words, the MS determines whether a condition for performing an adaptive BR is satisfied.

If the ACK packets are generated during the specific time period in an amount less than the threshold, proceeding to block 505, the MS performs a BR for transmission of an UL packet stored in the UL data queue. That is, the MS determines a required resource amount by considering a size of the DL packet stored in the UL data queue, and transmits a BRH including information on the required resource amount. In this situation, if there is a UL packet to be transmitted, the BR may be performed in a piggyback manner.

In block 507, the MS determines whether a resource is allocated according to the BR performed in block 505. In other words, the MS determines whether the UL resource is allocated by a required resource amount included in the BRH. Herein, allocation of the resource is achieved after an allocation delay time elapses.

When the resource is allocated, proceeding to block 509, the MS transmits the DL packet stored in the UL data queue by using the allocated resource. That is, the MS performs coding and modulation on a bit-stream of the UL packet to convert the bit-stream into complex symbols, and maps the complex symbols to the allocated resource. Thereafter, the MS configures an OFDM symbol by performing an IFFT operation and CP insertion. Further, the MS up-converts the OFDM symbols into an RF signal, and then transmits the RF signal through an antenna. Thereafter, the procedure returns to block 503.

If the packets are generated during the specific time period in an amount greater than or equal to the threshold in block 503, proceeding to block 511, the MS generates a periodic resource request BRH. The periodic resource request BRH includes required resource amount information, allocation count information, and allocation interval information. In other words, the periodic resource request BRH includes a BR indicating the required resource amount, a NUM indicating the allocation count, and an INT indicating the allocation interval. HT, EC, and type values are set to values indicating the periodic resource request BRH. Herein, a time in which the periodic allocation is maintained is greater than or equal to an allocation delay time.

After generating the periodic resource request BRH, proceeding to block 513, the MS performs an initial BR by using the periodic resource request BRH. In other words, the MS transmits the periodic resource request BRH.

In block 515, the MS determines whether a resource is allocated according to the initial BR performed in block 513 or the adaptive BR to be performed in block 519. In other words, the MS determines whether some UL resources are allocated among the required resource amount included in the BRH. Herein, the resource is allocated after an allocation delay time elapses.

When the resource is allocated, proceeding to block 517, the MS determines a required resource amount of the adaptive BR. Herein, the required resource amount of the adaptive BR is determined such that the ACK packets are transmitted without delay while minimizing padding. For example, the MS determines the required resource amount by selecting a greater value between a data amount of an ACK packet stored in a current UL data queue and a data amount of an old statistical ACK packet. For example, the data amount of the statistical ACK packet implies an average of data amounts of ACK packets stored in the UL data queue at respective transmission times of recent N frames.

After determining the required resource amount of the adaptive BR, proceeding to block 519, the MS transmits the ACK packet by using the allocated resource while performing the adaptive BR in a piggyback manner. That is, the MS transmits the ACK packet and a burst including the adaptive BR by using the allocated resource.

In block 521, the MS determines whether an ACK packet for DL TCP data is not generated during the specific time period. Herein, a length of the specific time period is not necessarily equal to the length of the specific time period in block 503, and thus the two lengths may be equal to or different from each other. If the ACK packet for the DL TCP data is not generated during the specific time period, the MS terminates the adaptive BR, and the procedure returns to block 503. Otherwise, if the ACK packet for the DL TCP data is persistently generated, returning to block 515, the MS performs the adaptive BR.

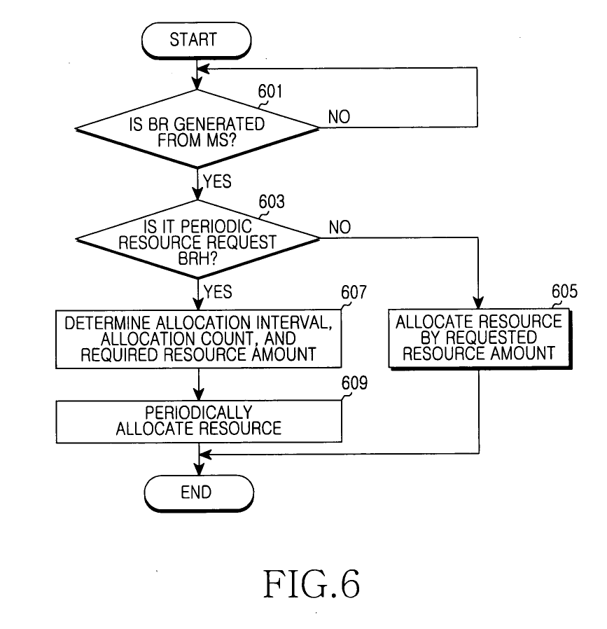

FIG. 6 illustrates an operation of a BS in a broadband wireless communication system according to an embodiment of the present invention.

Referring to FIG. 6, the BS, determines whether a BR is generated from an MS in block 601. In other words, the BS determines whether a BRH is received from the MS.

When the BR is generated, proceeding to block 603, the BS determines whether the BRH is a periodic resource request BRH. In other words, the BS determines whether the BR is an initial BR for an adaptive BR. Whether the BR is the periodic resource request BRH is determined by using HT, EC, and type values of the BRH.

If the BRH is not the periodic resource request BRH, proceeding to block 605, the BS allocates a UL resource by a required resource amount according to a typical mechanism. As a result, the BS generates and transmits a UL map message.

Otherwise, if the BRH is the periodic resource request BRH, proceeding to block 607, the BS determines an allocation interval, an allocation count, and a required resource amount by using the periodic resource request BRH. That is, the BS determines the allocation interval by using an INT included in the periodic resource request BRH, the allocation count by using the NUM, and the request resource amount by using the BR.

In block 609, the BS periodically allocates a resource to the MS according to the periodic resource request BRH. In other words, the BS allocates the resource by the required resource amount and by the allocation count in every allocation interval.

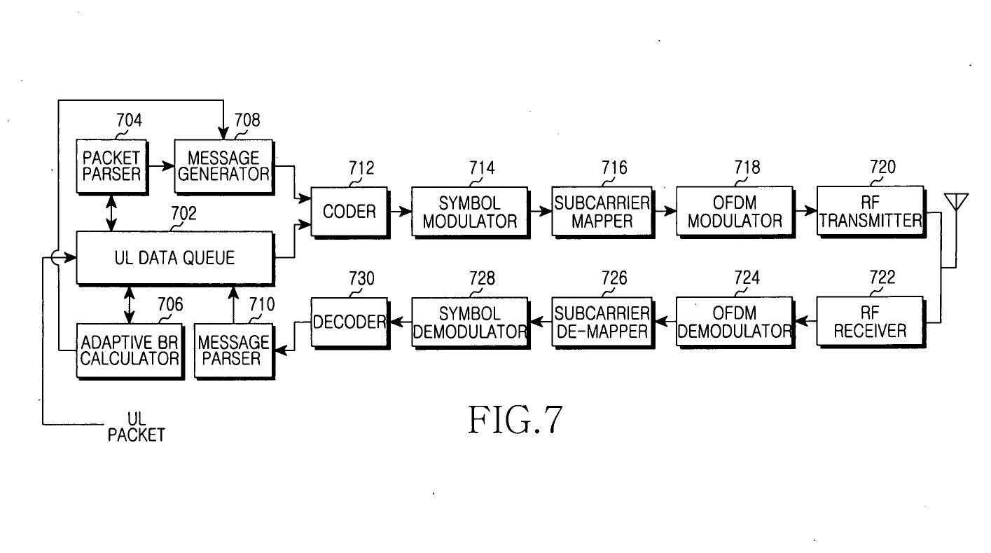

FIG. 7 illustrates an MS in a broadband wireless communication system according to an embodiment of the present invention.

Referring to FIG. 7, the MS includes a UL data queue 702, a packet parser 704, an adaptive BR calculator 706, a message generator 708, a message parser 710, a coder 712, a symbol modulator 714, a subcarrier mapper 716, an OFDM modulator 718, an RF transmitter 720, an RF receiver 722, an OFDM demodulator 724, a subcarrier de-mapper 726, a symbol demodulator 728, and a decoder 730.

The UL data queue 702 stores UL packets input from a higher layer of a MAC layer. The UL data queue 702 stores a data packet, an ACK packet, and such, and outputs the stored packet to the coder 712 according to a map message parsing result obtained by the message parser 710.

The packet parser 704 parses the UL packets to be input to the UL data queue 702. In other words, the packet parser 704 classifies the UL packets by using a size and an IP header. In particular, the packet parser 704 identifies an ACK packet for DL TCP data among the UL packets. Herein, the packet parser 704 classifies a TCP packet with a specific size or smaller into the ACK packet.

Further, the packet parser 704 determines whether to perform an adaptive BR. Herein, whether to perform the adaptive BR is determined according to whether the ACK packets for the DL TCP data are generated during a specific time period in an amount greater than or equal to a threshold. That is, the packet parser 704 determines whether the ACK packets for the DL TCP data are generated during the specific time period in an amount greater than or equal to the threshold, and if the ACK packets are generated during the specific time period in an amount greater than or equal to the threshold, the packet parser 704 controls the message generator 708 to generate a BRH for an adaptive BR. After the adaptive BR starts, if the ACK packets for the DL TCP data are not generated during the specific time period, the packet parser 704 provides control such that the adaptive BR is terminated.

The adaptive BR calculator 706 determines a required resource amount of the adaptive BR. Herein, the required resource amount of the adaptive BR is determined such that the ACK packets are transmitted without delay while minimizing padding. For example, the adaptive BR calculator 706 determines the required resource amount by selecting a greater value between a data amount of an ACK packet currently stored in the UL data queue 702 and a data amount of an old statistical ACK packet. For example, the data amount of the statistical ACK packet implies an average of data amounts of ACK packets stored in the UL data queue 702 at respective transmission times of recent N frames.

The message generator 708 generates a control message to be transmitted to a BS. In particular, the message generator 708 generates messages for an adaptive BR. That is, the message generator 708 generates a BRH for an initial BR and a BRH for the adaptive BR in a piggyback manner. Herein, a required resource amount of the BRH for the adaptive BR follows a value calculated by the adaptive BR calculator 706. In this case, the message generator 708 generates and outputs the BRH for the initial BR when the packet parser 704 instructs to perform the adaptive BR. Further, when an ACK is transmitted using an allocated resource according to the initial BR, the message generator 708 generates and outputs the BRH for the adaptive BR such that the adaptive BR is achieved in a piggyback manner. Herein, a type of the BRH for the initial BR may differ according to an embodiment of the present invention.

According to one embodiment of the present invention, the message generator 708 generates a BRH requesting a large resource amount as the BRH for the initial BR. Herein, the large resource amount is as large as that can be allocated across a plurality of frames, and indicates an amount exceeding a maximum amount of resources that can be allocated for each frame. In addition, the plurality of frames include a length greater than or equal to an allocation delay time. For example, if a maximum resource amount allocated per one frame is predetermined in a UL frame structure, the large resource amount is identical to a size corresponding to {maximum allocation size per frame}×{number of allocation delay frames}. On the other hand, according to another embodiment of the present invention, the message generator 708 generates a periodic resource request BRH as the BRH for the initial BR. The periodic resource request BRH includes required resource amount information, allocation count information, and allocation interval information. In other words, the periodic resource request BRH includes a BR indicating the required resource amount, a NUM indicating the allocation count, and an INT indicating the allocation interval. HT, EC, and type values are set to values indicating the periodic resource request BRH. Herein, a time in which the periodic allocation is maintained is greater than or equal to an allocation delay time.

The message parser 710 parses a control message received from the BS. For example, the message parser 710 identifies a resource allocated to the MS by parsing a map message.

The coder 712 performs channel coding on an information bit-stream provided from the UL data queue 702 and the message generator 708. The symbol modulator 714 modulates the channel-coded bit-stream to convert it into complex symbols. The subcarrier mapper 716 maps the complex symbols to a frequency domain. The OFDM modulator 718 converts the complex symbols mapped to the frequency domain into a time-domain signal by performing an IFFT operation, and configures an OFDM symbols by inserting a CP. The RF transmitter 720 up-converts a baseband signal into a DL-band signal and transmits the converted signal through an antenna.

The RF receiver 722 down-converts the DL-band signal received through the antenna into a baseband signal. The OFDM demodulator 724 divides a signal provided from the RF receiver 722 in an OFDM symbol unit, removes a CP, and restores the complex symbols mapped to the frequency domain by performing a Fast Fourier Transform (FFT) operation. The subcarrier de-mapper 726 classifies the complex symbols mapped to the frequency domain in a processing unit. The symbol demodulator 728 demodulates the complex symbols to convert them into a bit-stream. The decoder 730 restores an information bit-stream by performing channel decoding on the bit-stream.

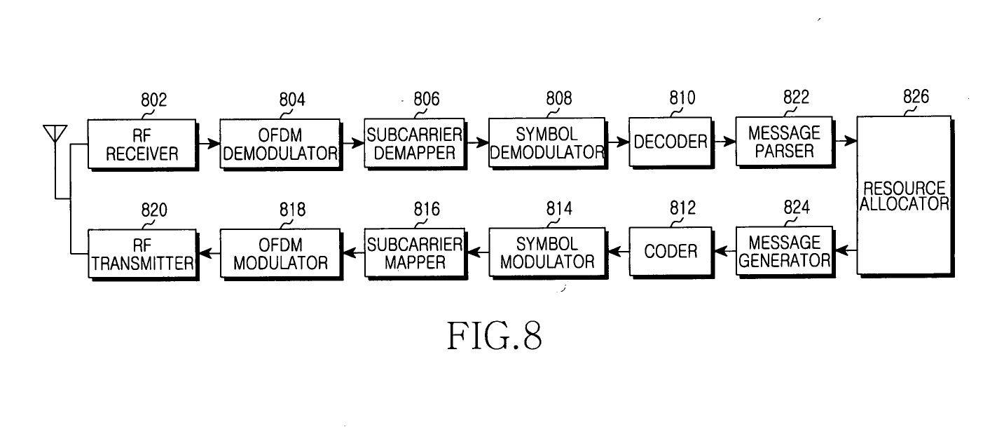

FIG. 8 illustrates a BS in a broadband wireless communication system according to an embodiment of the present invention.

Referring to FIG. 8, the BS includes an RF receiver 802, an OFDM demodulator 804, a subcarrier demapper 806, a symbol demodulator 808, a decoder 810, a coder 812, a symbol modulator 814, a subcarrier mapper 816, an OFDM modulator 818, an RF transmitter 820, a message parser 822, a message generator 824, and a resource allocator 826.

The RF receiver 802 down-converts a DL-band signal received through an antenna into a baseband signal. The OFDM demodulator 804 divides a signal in an OFDM symbol unit, removes a CP, and restores complex symbols mapped to a frequency domain by performing an FFT operation. The subcarrier demapper 806 classifies the complex symbols mapped to the frequency domain in a processing unit. The symbol demodulator 808 demodulates the complex symbols to convert them into a bit-stream. The decoder 810 performs channel decoding on the bit-stream to restore an information bit-stream.

The coder 812 performs channel coding on the information bit-stream provided from the message generator 824. The symbol modulator 814 modulates the channel-coded bit-stream to convert it into complex symbols. The subcarrier mapper 816 maps the complex symbols to the frequency domain. The OFDM modulator 818 converts the complex symbols mapped to the frequency domain into a time-domain signal by performing an IFFT operation and configures an OFDM symbol by inserting a CP. The RF transmitter 820 up-converts a baseband signal into a DL-band signal and transmits the DL-band signal through the antenna.

The message parser 822 parses a control message received from an MS. For example, the message parser 822 parses a BRH for a BR to identify a resource amount requested by the MS. In particular, when the BR is generated, the message parser 822 determines whether the received BRH is a periodic resource request BRH. In other words, the message parser 822 identifies whether the BR is an initial BR for an adaptive BR. Whether it is the periodic resource request BRH is determined by using HT, EC, and type values of the BRH. Upon receiving the periodic resource request BRH, the message parser 822 determines an allocation interval, an allocation count, and a required resource amount by using the periodic resource request BRH. That is, the message parser 822 determines the allocation interval by using an INT included in the periodic resource request BRH, the allocation count by using the NUM, and the request resource amount by using the BR.

The message generator 824 generates a control message transmitted to the MS. For example, the message generator 824 generates a map message for reporting a resource allocation result of the resource allocator 826. The resource allocator 826 allocates a DL resource and a UL resource to the MS. When the UL resource is allocated, the resource allocator 826 allocates the resource according to a required resource amount of the BR determined by the message parser 822. In particular, if a periodic resource request BRH is determined, the resource allocator 826 periodically allocates the resource to the MS according to the allocation interval, allocation count, and required resource amount included in the periodic resource request BRH. In other words, the resource allocator 826 allocates the resource by the required resource amount and by the allocation count in every allocation interval.

According to embodiments of the present invention, a BR is performed by predicting generation of an ACK packet in a broadband wireless communication system such that resource allocation is not delayed. Therefore, the ACK packet is transmitted without delay, thereby increasing a transfer rate.

What is claimed is:

1. A method of a Bandwidth Request (BR) of a Mobile Station (MS) in a wireless communication system, the method comprising:
performing an initial BR to allocate resources across a plurality of frames; and
performing an adaptive BR on a resource in a piggyback manner by using the resource while transmitting an acknowledge (ACK) packet for downlink Transmission Control Protocol (TCP) data when the resource is allocated according to the initial BR.

2. The method of claim 1, wherein performing the initial BR comprises transmitting a Bandwidth Request Header (BRH) requesting a resource amount that exceeds a maximum amount of an allocable resource per frame.

3. The method of claim 1, wherein performing the initial BR comprises transmitting a BRH periodically requesting a specific amount of the resource.

4. The method of claim 3, wherein the BRH periodically requesting the specific amount of resource comprises at least one of an allocation interval, an allocation count, and a required resource amount.

5. The method of claim 1, further comprising:
identifying ACK packets for the downlink TCP data among uplink packets input to a Media Access Control (MAC) layer; and
performing the initial BR when the ACK packets for the downlink TCP data are generated during a first time period in an amount greater than or equal to a threshold.

6. The method of claim 1, further comprising determining a required resource amount of the adaptive BR.

7. The method of claim 6, wherein the required resource amount is determined such that the ACK packet can be transmitted without delay while minimizing padding.

8. The method of claim 7, wherein the required resource amount is determined to a value which is a greater value between a data amount of an ACK packet currently stored in an uplink data queue and a data amount of a statistical ACK packet.

9. The method of claim 8, wherein the data amount of the statistical ACK packet is an average of data amounts of the ACK packet stored in the uplink data queue at respective transmission times of recent N frames.

10. The method of claim 1, further comprising terminating the adaptive BR if the ACK packet for the downlink TCP data is not generated during a second time period.

11. A method of allocating a resource of a Base Station (BS) according to a Bandwidth Request (BR) in a wireless communication system, the method comprising:
upon receiving a Bandwidth Request Header (BRH) from a Mobile Station (MS), determining whether the BRH is a periodic resource request BRH;
in response to determining that the BRH is the periodic resource request BRH, identifying an allocation interval, an allocation count, and a required resource amount from the periodic resource request BRH; and
allocating the resource based on the required resource amount and by the allocation count in every allocation interval.

12. The method of claim 11, wherein the determining of whether the BRH is the periodic resource request BRH comprises determining whether a Header Type (HT) value, an Encryption Control (EC) value, and a type value of the BRH correspond to the periodic resource request BRH.

13. A Mobile Station (MS) apparatus in a wireless communication system, the apparatus comprising:
a generator configured to generate a control message for an initial BR to allocate resources across a plurality of frames; and
a transmitter configured to transmit an acknowledge (ACK) packet for downlink Transmission Control Protocol (TCP) data and a burst comprising control information for an adaptive BR in a piggyback manner by using a resource, when the resource is allocated by the initial BR.

14. The apparatus of claim 13, wherein, as a control message for the initial BR, the generator generates a Bandwidth Request Header (BRH) requesting a resource amount exceeding a maximum amount of an allocable resource per frame.

15. The apparatus of claim 13, wherein, as a control message for the initial BR, the generator generates a BRH periodically requesting a specific amount of the resource.

16. The apparatus of claim 15, wherein the BRH periodically requesting the specific amount of resource comprises at least one of an allocation interval, an allocation count, and a required resource amount.

17. The apparatus of claim 13, further comprising a parser configured to:
identify ACK packets for the downlink TCP data among uplink packets input to a Media Access Control (MAC) layer, and
generate the initial BR when the ACK packets for the downlink TCP data are generated during a first time period in an amount greater than or equal to a threshold.

18. The apparatus of claim 13, further comprising a calculator configured to determine a required resource amount of the adaptive BR.

19. The apparatus of claim 18, wherein the required resource amount is determined such that the ACK packet can be transmitted without delay while minimizing padding.

20. The apparatus of claim 19, wherein the required resource amount is determined to a value which is a greater value between a data amount of an ACK packet currently stored in an uplink data queue and a data amount of a statistical ACK packet.

21. The apparatus of claim 20, wherein the data amount of the statistical ACK packet is an average of data amounts of the ACK packet stored in the uplink data queue at respective transmission times of recent N frames.

22. The apparatus of claim 13, further comprising a parser configured to terminate the adaptive BR when an ACK packet for the downlink TCP data is not generated during a second time period.

23. A Base Station (BS) apparatus in a wireless communication system, the apparatus comprising:
a parser configured to determine whether a Bandwidth Request Header (BRH) is a periodic resource request BRH upon receiving the BRH from a Mobile Station (MS) and, in response to determining that the BRH is the periodic resource request BRH, identify an allocation interval, an allocation count, and a required resource amount by using the periodic resource request BRH; and
an allocator configured to allocate the resource by the required resource amount and by the allocation count in every allocation interval.

24. The apparatus of claim 23, wherein, in order to determine whether the BRH is the periodic resource request BRH, the parser determines whether a Header Type (HT), Encryption Control (EC), and type values of the BRH correspond to the periodic resource request BRH.
